(19) United States
(12) Patent Application Publication
(10) Pub. No.: US 2023/0032219 A1
(43) Pub. Date: Feb. 2, 2023

(54) DISPLAY CONTROL METHOD, DISPLAY CONTROL APPARATUS, PROGRAM, AND RECORDING MEDIUM

(71) Applicant: SZ DJI TECHNOLOGY CO., LTD., Shenzhen (CN)

(72) Inventor: Guangyao LIU, Shenzhen (CN)

(73) Assignee: SZ DJI TECHNOLOGY CO., LTD., Shenzhen (CN)

(21) Appl. No.: 17/962,484

(22) Filed: Oct. 8, 2022

Related U.S. Application Data
(63) Continuation of application No. PCT/CN2021/081585, filed on Mar. 18, 2021.

(30) Foreign Application Priority Data
Apr. 9, 2020 (JP) 2020-070330

(51) Int. Cl. G06T 11/20; G06T 11/00; G01C 21/00; G05D 1/00

(52) U.S. Cl. CPC G06T 11/203; G06T 11/001; G01C 21/3804; G05D 1/0044

(57) ABSTRACT

A display control method for easily and intuitively recognizing a height of a flight path of a flight object is provided. The display control method is used to control the display of the flight path of the flight object and includes the following steps: obtaining a two-dimensional (2D) map including longitude and latitude information; obtaining the flight path of the flight object in three-dimensional (3D) space; and determining a display mode of the flight path superimposed and displayed on the 2D map based on a height of the flight path.

### RELATED APPLICATIONS

This application is a continuation application of PCT application No. PCT/CN2021/081585, filed on Mar. 18, 2021, which claimed the benefit of priority of Japanese Patent Application No. JP2020-070330, filed on Apr. 9, 2020, and the contents of the foregoing documents are incorporated herein by reference in their entireties.

### TECHNICAL FIELD

The present disclosure relates to a display control method to control the display of a flight path of a flight object, a display control apparatus, a program, and a recording medium.

### BACKGROUND

Conventionally, it is known to display a flight path on a map including longitude and latitude information. For example, a flight path may be set and displayed to show an unmanned aerial vehicle (UAV) sequentially passes through positions D1, D2, and D3, and finally returns to D1.
Patent literature 1: Japanese Patent Publication No. 2017-222187

### BRIEF SUMMARY

In patent literature 1, the heights at positions in a flight path is not considered, when showing the flight path. Therefore, it is difficult for a user to intuitively recognize the heights of the flight path when recognizing the flight path.

According to one aspect, a display control method to control display of a flight path of a flight object is provided, including: obtaining a two-dimensional (2D) map including longitude and latitude information; obtaining a flight path of a flight object in a three-dimensional (3D) space; and determining, based on a height of the flight path, a display mode of the flight path superimposed and displayed on the 2D map.

According to another aspect, a display control apparatus configured to control display of a flight path of a flight object is provided, including: a processing member, configured to: obtain a two-dimensional (2D) map including longitude and latitude information, obtain a flight path of a flight object in a three-dimensional (3D) space, and determine, based on a height of the flight path, a display mode of the flight path superimposed and displayed on the 2D map.

According to yet another aspect, a computer-readable recording medium having a program to enable a display control apparatus configured to control display of a flight path of a flight object to: obtain a two-dimensional (2D) map including longitude and latitude information, obtain a flight path of a flight object in a three-dimensional (3D) space, and determine, based on a height of the flight path, a display mode of the flight path superimposed and displayed on the 2D map.

The foregoing summary is not exhaustive of all features of the present disclosure. In addition, some of these features may also be combined if appropriate.

### BRIEF DESCRIPTION OF THE DRAWINGS

FIG. 1 is a schematic diagram of a composition example of a flight object system according to some exemplary embodiments;

FIG. 2 is a diagram of an example of a specific appearance of a UAV;

FIG. 3 is a block diagram of an example of a hardware composition of a UAV;

FIG. 4 is a block diagram of an example of a hardware composition of a terminal;

FIG. 5 is a flowchart of an example of actions of a terminal when a flight path is displayed in a first display mode;

FIG. 6 is a diagram of a display example of a first flight path in a first display mode;

FIG. 7 is a diagram of a display example of a second flight path in a first display mode;

FIG. 8 is a flowchart of an example of actions of a terminal when a flight path is displayed in a second display mode;

FIG. 9 is a diagram of a display example of a third flight path in a second display mode;

FIG. 10 is a diagram of display of a flight path in a comparative example; and

FIG. 11 is a diagram of display of a flight path in which height information at a predetermined position of the flight path is supplemented by text in a comparative example.

### DETAILED DESCRIPTION

The following describes the present disclosure with reference to some exemplary embodiments. However, the following exemplary embodiments do not limit the present disclosure. All combinations of features described in the exemplary embodiments may not be necessary for the solutions of the present disclosure.

The claims, the specification, the drawings accompanying the specification, and the abstract of the specification include matters that are the subject of copyright protection. The copyright holder will not raise an objection to any reproduction of these documents by any person who makes such reproduction as indicated in the documents or records of the Patent Office. However, all copyrights are reserved except for the foregoing case.

Background of implementing one aspect of the present disclosure:

In recent years, there has been an increasing demand for automatic flight in various fields utilizing UAVs. To preplan the automatic flight of a UAV, persons with expertise in various fields need to design a flight path for the UAV on a map. Maps referred to herein for designing the flight path may include a two-dimensional (2D) map including latitude and longitude information, and a three-dimensional (3D) map including latitude, longitude, and height information. Currently, a method for planning a flight path on a 2D map is often used in software or an application program for generating a flight path (hereinafter referred to as a flight path generation application). This is due to the fact that 2D maps have more general maps than 3D maps, are easy to install, and have a relatively small processing load for the flight path generation application. In addition, when the flight path is generated on a 3D map, a viewpoint for displaying the 3D map needs to be taken into consideration, and efforts need to be made in rendering. When the flight path is generated on a 2D map, these issues do not need be taken into consideration.

For example, a flight path generated by a flight path generation application may be displayed by software or an application for displaying a flight path (hereinafter referred to as a flight path display application), which may be recognized by a user.

When an altitude of the ground in a flight range in which a UAV flies varies, a flight height in the flight path in the flight range may mostly varies. However, in an existing flight path display application, it is difficult to recognize a height change in the flight path. Therefore, it is difficult to grasp an overall flight situation in the flight path, ensure the correctness of the flight path, and distinguish between a plurality of flight paths at a same latitude and longitude. For example, information indicating the flight path may appear at first glance as a simple straight line, but the height may sequentially changes.

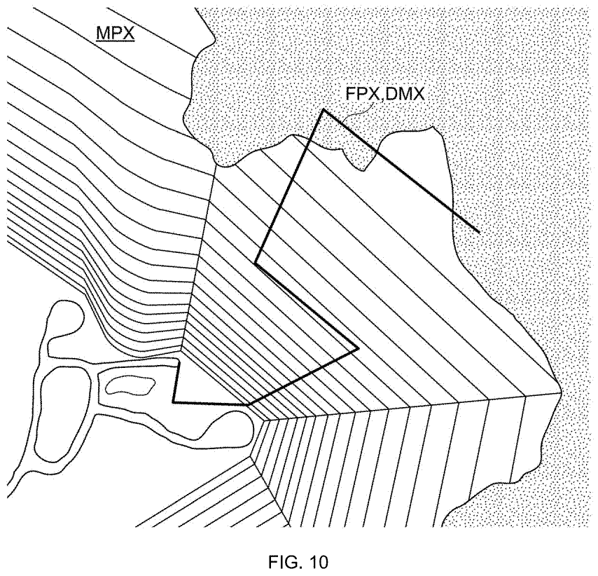

FIG. 10 is a diagram of an example of display of a flight path FPX superimposed on a 2D map MPX in a comparative example. On the 2D map MPX shown in FIG. 10, the flight path FPX is superimposed and displayed. The flight path FPX is a path of a UAV to investigate a cliff collapse site. Therefore, the flight path FPX has a height difference along at least a region of a cliff on the map. In FIG. 10, the flight path FPX having a height difference is displayed in a display mode DMX. In the display mode DMX, the flight path FPX is showed as a line with a uniform thickness. Therefore, it is difficult to recognize a position(s) with a higher height and a position(s) with a lower height in the flight path FPX.

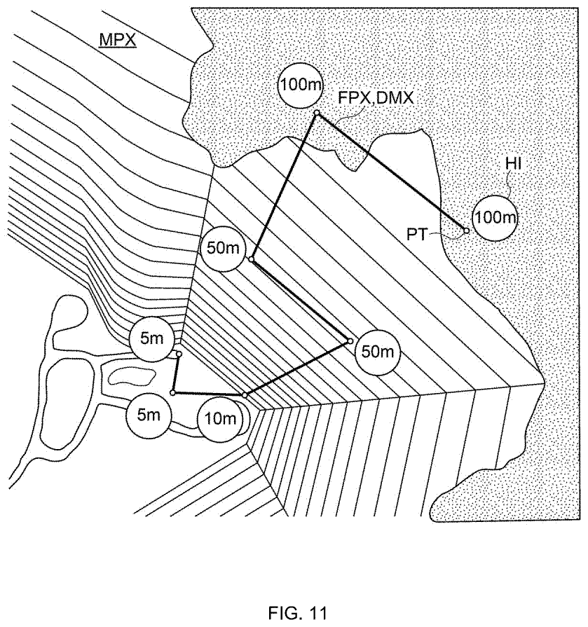

FIG. 11 is a diagram of an example of display of the flight path FPX superimposed on the 2D map MPX in the comparative example, where the height information HI at a predetermined position in the flight path FPX is supplemented by text. The 2D map MPX and the flight path FPX shown in FIG. 11 are the same as those shown in FIG. 10. In FIG. 11, in comparison with FIG. 10, the height information HI at a position PT at which a flight direction in the flight path FPX changes is represented by text information. For example, the text information is shown in a lead-out box corresponding to the position PT. A user to confirm the display of the flight path FPX may recognize the height by recognizing the text information. However, even in this case, only the height of part of the flight path FPX may be known, and it is difficult to intuitively understand the line representing the flight path FPX and obtain an overall outline of the flight path FPX in consideration of the height.

In the following exemplary embodiments, a display control method for easily and intuitively recognizing a height of a flight path of a flight object, a display control apparatus, a program, and a recording medium will be described.

In the following exemplary embodiments, an example in which the flight object is a UAV is used. The display control apparatus may be, for example, a terminal or another apparatus (such as a UAV, a server, or another display control apparatus). The display control method defines actions of the display control apparatus. In addition, a program (for example, a program used to enable the display control apparatus to perform various processing) is recorded in the recording medium.

A “member” or “apparatus” described in the following exemplary embodiments is not limited to a physical structure implemented by hardware, but also includes a function of the structure implemented by software such as a program. A function of one structure may be implemented by two or more physical structures, or functions of two or more structures may be implemented by, for example, one physical structure. “Obtain” in the embodiments is not limited to an action of directly obtaining information, a signal, or the like, and includes, for example, obtaining from a storage member (such as a memory) in addition to obtaining, that is, receiving by a processing member via a communication member. Understanding and interpretation of these terms are the same in the description of the claims.

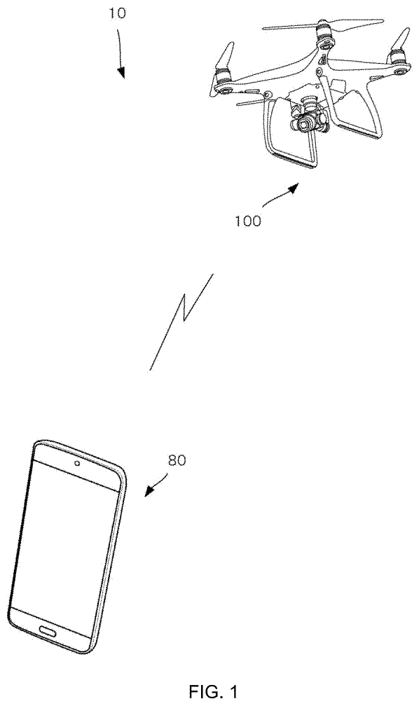

FIG. 1 is a schematic diagram of a composition example of a flight object system 10 according to some exemplary embodiments. The flight object system 10 may include a UAV 100 and a terminal 80. The UAV 100 and the terminal 80 may communicate with each other via in a wired or wireless manner. In FIG. 1, the terminal 80 is a portable terminal (such as a smartphone or a tablet terminal) or another terminal (such as a personal computer (PC) or a transmitter (wireless proportional controller) that may operate the UAV 100 with a joystick).

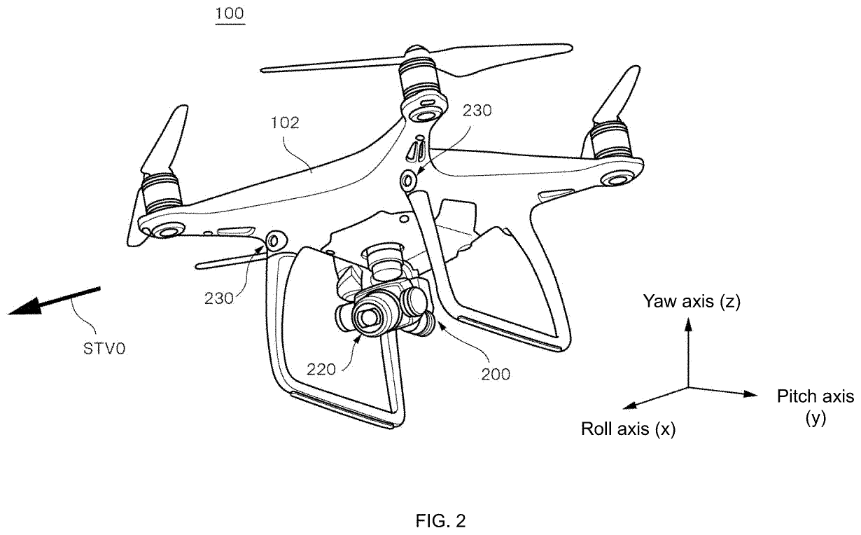

FIG. 2 is a diagram of an example of a specific appearance of the UAV 100. FIG. 2 is a perspective view of the UAV 100 when it flies in a movement direction STV0. The UAV 100 is an example of a movable object.

As shown in FIG. 2, a roll axis (x-axis) is provided in a direction parallel to the ground and in the movement direction STV0. In this case, a pitch axis (y-axis) is provided in a direction parallel to the ground and perpendicular to the roll axis, and a yaw axis (z-axis) is provided in a direction perpendicular to the ground and perpendicular to the roll axis and the pitch axis.

The UAV 100 may include a UAV main body 102, a gimbal 200, a photographing member 220, and a plurality of photographing members 230.

The UAV main body 102 may include a plurality of rotors (propellers). The UAV main body 102 may control the plurality of rotors to rotate to enable the UAV 100 to fly. The UAV main body 102 may use, for example, four rotors to enable the UAV 100 to fly. A quantity of the rotors is not limited to four. Alternatively, the UAV 100 may be a fixed-wing aircraft without any rotor.

The photographing member 220 may be a camera for photographing a to-be-photographed object (for example, an overhead situation, scenery such as mountains and rivers, or a building on the ground) in a desired photographing range.

The plurality of photographing members 230 may be sensing cameras for photographing surroundings of the UAV 100 in order to control the flight of the UAV 100. Two of the photographing members 230 may be provided on a nose of the UAV 100, that is, on a front side. The other two photographing members 230 may be provided on a bottom surface of the UAV 100. The two photographing members 230 on the front side may be paired to function as stereo cameras. The two photographing members 230 on the bottom surface may also be paired to function as stereo cameras. 3D spatial data around the UAV 100 may be generated based on images captured by the plurality of photographing members 230. In addition, a quantity of the photographing members 230 provided for the UAV 100 is not limited to four. The UAV 100 may have at least one photographing member 230. Alternatively, the UAV 100 may include at least one photographing member 230 on each of the nose, a tail, a side surface, the bottom surface, and a top surface of the UAV 100. A viewing angle that may be set for the photographing member 230 may be greater than a viewing angle that may be set for the photographing member 220. The photographing member 230 may have a single focus lens or a fisheye lens.

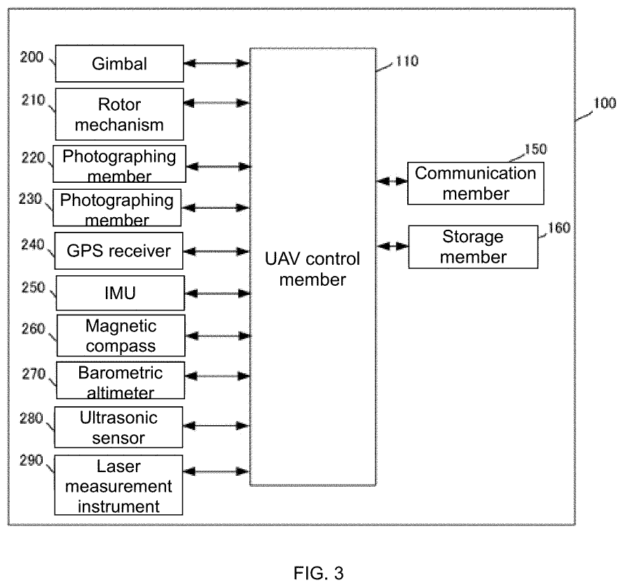

FIG. 3 is a block diagram of an example of a hardware composition of the UAV 100. The UAV 100 may include a UAV control member 110, a communication member 150, a storage member 160, a gimbal 200, a rotor mechanism 210, the photographing member 220, the photographing member 230, a global positioning system (GPS) receiver 240, an inertial measurement unit (IMU) 250, a magnetic compass 260, a barometric altimeter 270, an ultrasonic sensor 280, and a laser measurement instrument 290.

The UAV control member 110 may include, for example, a central processing unit (CPU), a micro processing unit (MPU), or a digital signal processor (DSP). The UAV control member 110 may perform signal processing for overall control of an action of each member of the UAV 100, input/output processing of data to/from other members, arithmetic processing of data, and storage processing of data.

The UAV control member 110 may control the flight of the UAV 100 based on a program stored in the storage member 160. In this case, the UAV control member 110 may control the flight based on a specified flight path. The UAV control member 110 may control the flight based on an instruction of flight control from the terminal 80, such as an operation. The UAV control member 110 may capture images (such as moving images and still images) (for example, aerial photographing).

The UAV control member 110 may obtain position information indicating a position of the UAV 100. The UAV control member 110 may obtain the position information indicating the latitude, longitude, and height at which the UAV 100 is located from the GPS receiver 240. The UAV control member 110 may obtain latitude and longitude information indicating the latitude and longitude at which the UAV 100 is located from the GPS receiver 240, and height information indicating the height at which the UAV 100 is located from the barometric altimeter 270, as the position information. The UAV control member 110 may obtain a distance between a radiation point and a reflection point of an ultrasonic wave generated by the ultrasonic sensor 280 as the height information.

The UAV control member 110 may obtain orientation information indicating an orientation of the UAV 100 from the magnetic compass 260. The orientation information may be represented by, for example, an azimuth of an orientation of the nose of the UAV 100.

The UAV control member 110 may obtain the position information indicating a position at which the UAV 100 should be located when the photographing member 220 performs photographing in a photographing range. The UAV control member 110 may obtain the position information indicating the position at which the UAV 100 should be located from the storage member 160. The UAV control member 110 may obtain the position information indicating the position at which the UAV 100 should be located from another apparatus via the communication member 150. The UAV control member 110 may specify a position at which the UAV 100 may be located with reference to a 3D map database, and obtain the position as the position information indicating the position at which the UAV 100 should be located.

The UAV control member 110 may obtain photographing ranges of the photographing member 220 and the photographing member 230. The UAV control member 110 may obtain viewing angle information indicating viewing angles of the photographing member 220 and the photographing member 230 from the photographing member 220 and the photographing member 230 as parameters for determining the photographing ranges. The UAV control member 110 may obtain information indicating photographing directions of the photographing member 220 and the photographing member 230 as parameters for determining the photographing ranges. The UAV control member 110 may obtain orientation information indicating an orientation of the photographing member 220, for example, as the information indicating the photographing direction of the photographing member 220 from the gimbal 200. The orientation information of the photographing member 220 may indicate an angle of rotation of the gimbal 200 from a reference angle of rotation of the pitch axis and the yaw axis.

The UAV control member 110 may obtain the position information indicating the position of the UAV 100 as a parameter for determining the photographing range. The UAV control member 110 may limit, based on the viewing angles and the photographing directions of the photographing member 220 and the photographing member 230, and the position of the UAV 100, the photographing range indicating a geographical range photographed by the photographing member 220.

The UAV control member 110 may obtain photographing range information from the storage member 160. The UAV control member 110 may obtain the photographing range information via the communication member 150.

The UAV control member 110 may control the gimbal 200, the rotor mechanism 210, the photographing member 220, and the photographing member 230. The UAV control member 110 may control the photographing range of the photographing member 220 by changing the photographing direction or the viewing angle of the photographing member 220. The UAV control member 110 may control the photographing range of the photographing member 220 supported by the gimbal 200 by controlling the rotation mechanism of the gimbal 200.

The photographing range may be a geographical range photographed by the photographing member 220 or the photographing member 230. The photographing range may be defined by the latitude, longitude, and height. The photographing range may be a range of 3D spatial data defined by the latitude, longitude, and height. The photographing range may be a range of 2D spatial data defined by the latitude and longitude. The photographing range may be determined based on the viewing angle and the photographing direction of the photographing member 220 or the photographing member 230, and the position of the UAV 100. The photographing directions of the photographing members 220 and 230 may be defined by azimuths and depression angles of front faces of the photographing members 220 and 230 on which photographing lenses are provided. The photographing direction of the photographing member 220 may be a direction determined based on the azimuth of the nose of the UAV 100 and the orientation of the photographing member 220 with respect to the gimbal 200. The photographing direction of the photographing member 230 may be a direction determined based on the azimuth of the nose of the UAV 100 and the position of the photographing member 230.

The UAV control member 110 may determine a surrounding environment of the UAV 100 by analyzing a plurality of images captured by the plurality of photographing members 230. The UAV control member 110 may control the flight based on the surrounding environment of the UAV 100, such as avoiding obstacles.

The UAV control member 110 may obtain stereoscopic information (3D information) indicating a stereoscopic shape (3D shape) of an object existing around the UAV 100. The object may be, for example, part of a building, road, vehicle, tree, or the like. The stereoscopic information may be, for example, 3D spatial data. The UAV control member 110 may generate the stereoscopic information indicating the stereoscopic shape of the object existing around the UAV 100 based on the images obtained by the plurality of photographing members 230, so as to obtain the stereoscopic information. The UAV control member 110 may obtain the stereoscopic information indicating the stereoscopic shape of the object existing around the UAV 100 by referring to a 3D map database stored in the storage member 160. The UAV control member 110 may obtain the stereoscopic information related to the stereoscopic shape of the object existing around the UAV 100 by referring to a 3D map database managed by a server on a network.

The UAV control member 110 may control the flight of the UAV 100 by controlling the rotor mechanism 210. That is, the UAV control member 110 may control the position, including the latitude, longitude, and height, of the UAV 100 by controlling the rotor mechanism 210. The UAV control member 110 may control the photographing range of the photographing member 220 by controlling the flight of the UAV 100. The UAV control member 110 may control the viewing angle of the photographing member 220 by controlling a zoom lens included in the photographing member 220. The UAV control member 110 may use a digital zoom function of the photographing member 220 to control the viewing angle of the photographing member 220 by digital zooming.

When the photographing member 220 is fixed to the UAV 100 and cannot be moved, the UAV control member 110 may enable the photographing member 220 to photograph the desired photographing range in a desired environment by moving the UAV 100 to a specific position at a specific time on a specific date. Alternatively, even if the photographing member 220 does not have a zoom function and the viewing angle of the photographing member 220 cannot be changed, the UAV control member 110 may enable the photographing member 220 to photograph the desired photographing range in the desired environment by moving the UAV 100 to the specific position at the specific time on the specific date.

The communication member 150 communicates with the terminal 80. The communication member 150 may perform wireless communication in any wireless communication manner. The communication member 150 may perform wired communication in any wired communication manner. The communication member 150 may send captured images or additional information (metadata) about the captured images to the terminal 80. The communication member 150 may receive information about the flight path from the terminal 80.

The storage member 160 may store various types of information, various data, various programs, and various images. The various images may include captured images or images based on the captured images. The programs may include programs for the UAV control member 110 to control the gimbal 200, the rotor mechanism 210, the photographing member 220, the GPS receiver 240, the IMU 250, the magnetic compass 260, the barometric altimeter 270, the ultrasonic sensor 280, and the laser measurement instrument 290. The storage member 160 may be a computer-readable storage medium. The storage member 160 may include a memory, and may include a read-only memory (ROM), a random access memory (RAM), or the like. The storage member 160 may include at least one of a hard disk drive (HDD), a solid-state drive (SSD), a secure digital (SD) card, a universal serial bus (USB) memory, or another type of memory. At least part of the storage member 160 may be removable from the UAV 100.

The gimbal 200 may rotatably support the photographing member 220 about the yaw axis, the pitch axis, and the roll axis. The gimbal 200 may change the photographing direction of the photographing member 220 by rotating the photographing member 220 about at least one of the yaw axis, the pitch axis, or the roll axis.

The rotor mechanism 210 may have a plurality of rotors and a plurality of drive motors for rotating the plurality of rotors. The UAV control member 110 may control the rotor mechanism 210 to rotate, to enable the UAV 100 to fly.

The photographing member 220 may photograph a to-be-photographed object in the desired photographing range and generates data of the captured image. The data of an image captured by the photographing member 220 may be stored in a memory included in the photographing member 220 or the storage member 160.

The photographing member 230 may photograph the surroundings of the UAV 100 and generates data of captured images. The image data of the photographing member 230 may be stored in the storage member 160.

The GPS receiver 240 may receive a plurality of signals indicating times sent from a plurality of navigation satellites (namely, GPS satellites) and positions (coordinates) of the GPS satellites. The GPS receiver 240 may calculate the position of the GPS receiver 240 (namely, the position of the UAV 100) based on the plurality of signals received. The GPS receiver 240 may output the position information of the UAV 100 to the UAV control member 110. In addition, the UAV control member 110 instead of the GPS receiver 240 may calculate the position information of the GPS receiver 240. In this case, the information indicating the time and the position of each GPS satellite included in the plurality of signals received by the GPS receiver 240 may be input to the UAV control member 110.

The IMU 250 may detect the orientation of the UAV 100 and output a detection result to the UAV control member 110. The IMU 250 may detect accelerations of the UAV 100 in front-rear, left-right, and up-down directions and angular velocities in the directions of the pitch axis, roll axis, and yaw axis as the orientation of the UAV 100.

The magnetic compass 260 may detect the azimuth of the nose of the UAV 100 and output a detection result to the UAV control member 110.

The barometric altimeter 270 may detect the flight height of the UAV 100 and outputs a detection result to the UAV control member 110.

The ultrasonic sensor 280 may emit ultrasonic waves, detect ultrasonic waves reflected by the ground or an object, and output a detection result to the UAV control member 110. The detection result may indicate a distance between the UAV 100 and the ground, namely, the height. The detection result may indicate a distance between the UAV 100 and the object (photographed object).

The laser measurement instrument 290 may emit a laser to an object, receive light reflected by the object, and measure a distance between the UAV 100 and the object (photographed object) based on the reflected light. A time-of-flight method may be used as an example of a laser-based distance measurement method.

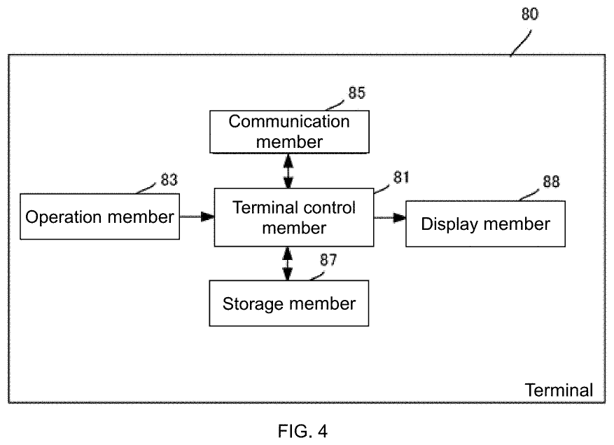

FIG. 4 is a block diagram of an example of a hardware composition of the terminal 80. The terminal 80 may include a terminal control member 81, an operation member 83, a communication member 85, a storage member 87, and a display member 88. The terminal 80 may be held by a user desiring to instruct the flight control of the UAV 100. The terminal 80 may instruct flight control of the UAV 100.

The terminal control member 81 may include, for example, a CPU, an MPU, or a DSP. The terminal control member 81 may perform signal processing for overall control of an action of each member of the terminal 80, input/output processing of data to/from other members, arithmetic processing of data, and storage processing of data.

The terminal control member 81 may obtain data or information from the UAV 100 via the communication member 85. The terminal control member 81 may also obtain data or information input with the operation member 83. The terminal control member 81 may also obtain data or information stored in the storage member 87. The terminal control member 81 may send data and information to the UAV 100 via the communication member 85. The terminal control member 81 may send data or information to the display member 88 and enable the display member 88 to display displayed information based on the data or information. The information displayed by the display member 88 and sent to the UAV 100 via the communication member 85 may include: information about the flight path of the UAV 100, a photographing position, a captured image, and an image based on the captured image.

The operation member 83 may receive and obtain data or information input by a user of the terminal 80. The operation member 83 may include an input apparatus such as a button, a key, a touch panel, or a microphone. The touch panel may include the operation member 83 and the display member 88. In this case, the operation member 83 may receive a touch operation, a click operation, a drag operation, or the like.

The communication member 85 may perform wireless communication with the UAV 100 in various wireless communication manners. For example, the wireless communication manners may include communication through a wireless local area network (LAN) or a public wireless line. The communication member 85 may perform wired communication in any wired communication manner.

The storage member 87 may store various types of information, various data, various programs, and various images. The various programs may include application programs executed by the terminal 80. The storage member 87 may be a computer-readable storage medium. The storage member 87 may include a ROM, a RAM, or the like. The storage member 87 may include at least one of an HDD, an SSD, an SD card, a USB memory, or another type of memory. At least part of the storage member 87 may be removable from the terminal 80.

The storage member 87 may store a captured image obtained from the UAV 100 or an image based on the captured image. The storage member 87 may store additional information of the captured image or the image based on the captured image.

The display member 88 may include, for example, a liquid crystal display (LCD), and display various information and data output from the terminal control member 81. For example, the display member 88 may display the captured image or the image based on the captured image. The display member 88 may also display various data and information related to the execution of the application program. The display member 88 may display the information about the flight path of the UAV 100. The flight path may be displayed in various display modes.

The following will describe the display control of the flight path in detail.

The terminal control member 81 may perform processing related to the display control of the flight path FP. The terminal control member 81 may obtain the information about the flight path FP. The flight path FP may be a path of a single flight of the UAV 100. The flight path FP may be represented by a set of a plurality of flight positions at which the UAV 100 flies. The flight position may be a position in 3D space. Information about the flight position may include latitude, longitude, and height (flight height) information.

The terminal control member 81 may obtain the flight path FP by executing the flight path generation application to generate the flight path FP. The terminal control member 81 may obtain the flight path FP from an external server or the like via the communication member 85. The terminal control member 81 may obtain the flight path FP from the storage member 87. The flight path FP may be determined when a route is set.

The terminal control member 81 may generate the flight path FP by using the 2D map MP. The terminal control member 81 may obtain the 2D map MP via the communication member 85 or from the storage member 87, or may generate the 2D map MP based on the plurality of captured images obtained from the UAV 100. For example, the terminal control member 81 may specify, via the operation member 83, a plurality of 2D positions at which the UAV 100 flies on a 2D plane represented by the 2D map MP and heights at the plurality of 2D positions to determine a plurality of flight positions at which the UAV 100 flies during the flight in the 3D space. The terminal control member 81 may generate the flight path FP based on the plurality of determined flight positions (namely, the plurality of specified 2D positions and the heights).

The terminal 80 may generate the flight path FP by using the 2D map MP. This may facilitate the generation of the path and reduce the processing load of the terminal 80. In addition, in comparison with generating the path by using a 3D map, there is no need to determine a viewpoint or a line of sight for determining a region of the 3D space as a displayed object, and the terminal 80 may reduce workload of the user. Therefore, the user who generates the flight path FP may easily generate the path even if the user is not a professional who performs complex path design such as game design.

The terminal control member 81 may determine a display mode for displaying the flight path FP. There may be a plurality of display modes as described later. The terminal control member 81 may be configured to display the flight path in at least one of the plurality of display modes. The terminal control member 81 may enable the display member 88 to display the flight path FP in the determined display mode. The terminal control member 81 may superimpose and display the flight path FP on the 2D map MP. The terminal control member 81 may display the flight path FP such that the latitude and longitude of each position of the flight path FP coincide with the latitude and longitude of each position on the 2D map MP.

Therefore, the user may recognize the latitude and longitude of the flight path FP by recognizing the display position(s) of the flight path FP on the display member 88 regardless of the display mode of the flight path FP. In addition, the user may recognize the height of the flight path FP by recognizing the flight path FP displayed in the determined display mode. Therefore, the terminal 80 may easily and intuitively recognize the height of the flight path of the flight object.

The terminal control member 81 may send the information about the flight path FP to the UAV 100 via the communication member 85. The UAV control member 110 of the UAV 100 may obtain the information about the flight path FP via the communication member 150 and control the flight based on the flight path FP.

The following describes a first display mode of the flight path FP.

The first display mode is a display mode using a distance method. For example, a 2D map MP may be generated based on an image captured in a direction from the air toward the ground. Therefore, the higher the flight height, the larger or thicker the information indicating the flight path FP may be set, and the lower the flight height, the smaller or thinner the information indicating the flight path FP may be set. In this way, the terminal control member 81 may draw (display) the flight path FP in such a way that a user may convert a thickness W of a line representing the flight path FP into a distance from the air for easy understanding. That is, the user may understand that the flight height is high at a position of a thick part of the line representing the flight path FP; and the flight height is low at a position of a thin part of the line representing the flight path FP.

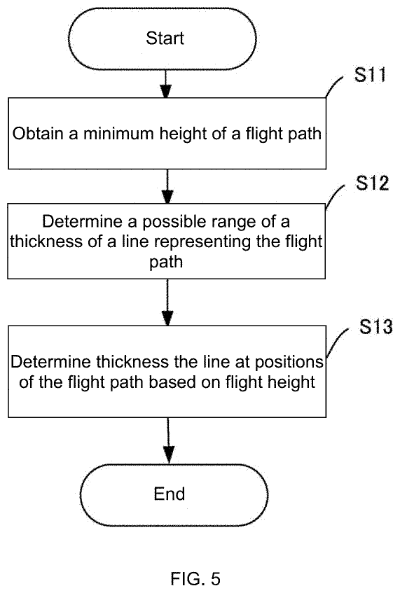

FIG. 5 is a flowchart of an example of actions of the terminal 80 when the flight path FP is displayed in the first display mode.

The terminal control member 81 may obtain the 2D map MP (S11). The terminal control member 81 may obtain information about the flight path FP (S11). The terminal control member 81 may obtain a minimum height Hmin in flight heights H at positions of the flight path FP (S11).

The terminal control member 81 may determine a possible range of the thickness W of the line representing the flight path FP (S12). A minimum value (minimum thickness) of the possible range of the thickness W of the line is set as a minimum value Wmin, and a maximum value (maximum thickness) is set as a maximum value Wmax. The possible range of the thickness W of the line may be determined based on the specifications of the terminal 80, an application to be executed (for example, the flight path generation application or the flight path display application), and the like.

The terminal control member 81 may determine the thickness W of the line at the position of the flight height H in the flight path FP, for example, based on Formula 1 (S13).

$$\begin{matrix}Formula 1 & \\ W = MIN ( W max , W min \cdot ε \cdot \frac{H}{H min} ) & ( 1 )\end{matrix}$$

In Formula 1, ε may be any value and may be arbitrarily set by a user. The greater ε, the more significant a change in the thickness W of the line. That is, the greater ε, the larger a change in the flight height H (Wmin×ε×H/Hmin), and the larger the change in the thickness W of the line relative to the change in the flight height H. Conversely, the smaller ε, the smaller the change in the flight height H (Wmin×ε×H/Hmin), and the smaller the change in the thickness W of the line relative to the change in the flight height H.

The flight height H may be an absolute height (altitude) or a relative height. For example, a minimum height of the ground corresponding to the flight path FP may be set to 0, and a relative height may be a height at which the UAV 100 flies relative to the minimum height of the ground. For example, the minimum height of the ground corresponding to the flight path FP is 100 to 200 meters. When the UAV flies while maintaining a height of 5 meters relative to the ground, a relative height of the UAV 100 relative to the ground is 5 to 105 meters. In this case, an absolute height of the UAV 100 is 105 to 205 meters.

The terminal control member 81 may determine whether the flight height H is an absolute height or a relative height. For example, the terminal control member 81 may obtain operation information of a user via the operation member 83, and determine whether the flight height H is an absolute height or a relative height based on the operation information.

In the foregoing example, since the relative height is less than the absolute height, the change in the thickness W of the line relative to the change in the flight height H becomes larger. Even if in this case, the terminal 80 may appropriately adjust the change in the thickness W of the line representing the flight path FP relative to the change in the flight height H by adjusting the value of c via the terminal control member 81.

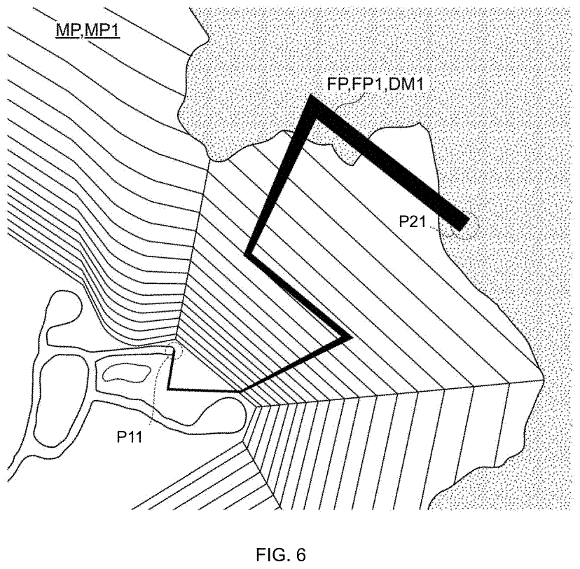

FIG. 6 is a diagram of a display example of a flight path FP1 (a first flight path) in a display mode DM1 (first display mode). The flight path FP1 is an example of the flight path FP. On a 2D map MP1 shown in FIG. 6, the flight path FP1 is superimposed and displayed. The 2D map MP1 is an example of the 2D map MP. The flight path FP1 is a path for investigating a cliff collapse site with the UAV 100. In the flight path FP1, the flight height H in the flight path FP1 may vary greatly along a cliff. The height of the UAV 100 relative to the ground is maintained fixed.

In the display mode DM1 shown in FIG. 6, a position P11 is below the cliff. Since the flight height H thereof is low, the line representing the flight path FP1 is thin. A position P12 is on the cliff. Since the flight height H thereof is high, the line representing the flight path FP1 is thick. A user may easily understand the flight height H at each position in the flight path FP1 by recognizing the thickness W of the line representing the flight path FP1. In addition, an overall situation of the flight in the flight path FP1 is provided in such a way that a user may easily control the UAV 100 to fly along the cliff.

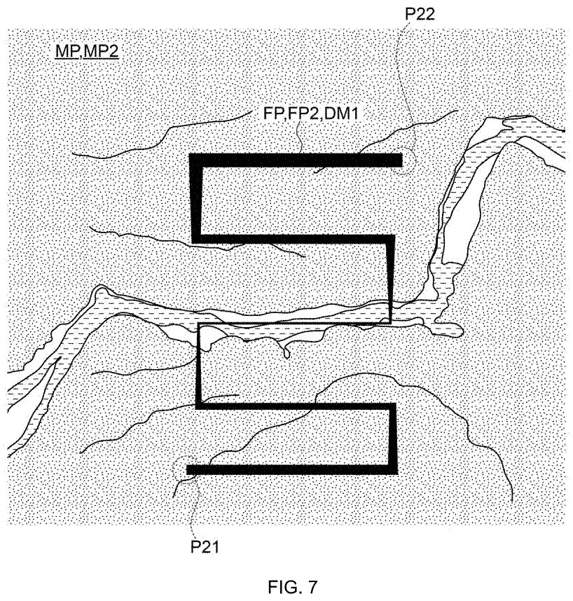

FIG. 7 is a diagram of a display example of a flight path FP2 (second flight path) in the display mode DM1. The flight path FP2 is an example of the flight path FP. On a 2D map MP2 shown in FIG. 7, the flight path FP2 is superimposed and displayed. The 2D map MP2 is an example of the 2D map MP. The flight path FP2 is a path for investigating the periphery of a river RV flowing through a mountain forest zone. In the flight path FP2, the flight height H in the flight path FP2 varies greatly along the periphery of the river RV. In the zone shown in FIG. 7, an altitude of a part along the river RV is low, and the altitude becomes higher along a part away from the river RV to both sides. The height of the UAV 100 relative to the ground is maintained fixed.

In the display mode DM1 shown in FIG. 7, the flight height at positions P21 and P22 may be higher than the flight height at the river RV, and the line representing the flight path FP2 is thicker. The flight height H at a position (a position corresponding to the river RV) near a center between the positions P21 and P22, such as a valley bottom, is lower than that in the surroundings, and the line indicating the flight path FP2 is thin. In addition, in a part of the flight path FP2 parallel to the river RV, the flight height H of the flight path FP does not change, and the thickness W of the line representing the flight path FP2 does not change, either. A user may easily understand the flight height H at each position in the flight path FP2 by recognizing the thickness W of the line representing the flight path FP2. In addition, an overall situation of the flight in the flight path FP2 is provided in such a way that a user may easily control the UAV 100 to turn around the river RV and the periphery of the river RV and fly while changing the direction.

FIG. 6 and FIG. 7 illustrate a flight range in which the height of the ground changes. However, even if in a flight range in which the height of the ground is fixed, when the flight height H of the flight path FP in the flight range changes, the thickness W of the line representing the flight path FP may also change. In addition, even if in the case of a cliff or a valley, the thickness W of the line representing the flight path FP may be fixed when the flight height H of the flight path FP is fixed regardless of the height of the ground.

In addition, although a case in which the line representing the flight path FP is superimposed and displayed on the 2D map MP without transparency is illustrated, the line representing the flight path FP may be superimposed and displayed on the 2D map MP with transparency. For example, the terminal control member 81 may superimpose and display the flight path FP on the 2D map MP in a semi-transparent state such that the terminal 80 may prevent a part of the 2D map MP on which the flight path FP is superimposed from being covered and unrecognizable.

In this way, the terminal 80 (an example of a display control apparatus) may control the display of the flight path FP of the UAV 100 (an example of the flight object). The terminal control member 81 (an example of a processing member) of the terminal 80 may obtain the 2D map MP including the longitude and latitude information. The terminal control member 81 may obtain the flight path FP of the UAV 100 in the 3D space. The terminal control member 81 may determine, based on the flight height H (an example of the height) of the flight path FP, the display mode of the flight path FP to be superimposed and displayed on the 2D map MP.

Therefore, the terminal 80 may intuitively learn the flight height H of the flight path FP by changing the display mode of the information indicating the flight path FP and simply viewing the display of the flight path FP. In comparison with the case in which the display mode is displayed in combination with the flight height H at an arbitrary position (referring to FIG. 11), the height information does not need to be used separately, the flight path FP may be easily and intuitively understood when the 2D map MP is recognized, and the flight path FP may be more easily understood in the 3D space.

In addition, the terminal control member 81 may determine the thickness of the line representing the flight path superimposed and displayed on the 2D map based on the height of the flight path FP. Because the flight height H of the flight path FP is reflected by the thickness W of the line representing the flight path FP, a user may understand a change in the flight height H at each position of the flight path FP by recognizing the thickness W of the line.

The greater/higher the height H of the flight path FP, the greater the thickness of the line representing the flight path FP may be, and the smaller the height of the flight path FP, the smaller the thickness of the line representing the flight path FP may be (that is, the height of the flight path is positively correlated with the thickness of the line representing the flight path FP). The 2D map is generated based on the image captured in the direction from the above to the ground. Therefore, the state of the line representing the flight path FP has a same appearance as other photographed objects in the 2D map FP. Therefore, the user can easily and intuitively understand the flight height H of the flight path FP displayed on the 2D map FP.

In addition, the terminal control member 81 may adjust the change in the thickness W of the line relative to the change in the flight height H of the flight path FP. The terminal control member 81 may adjust the change by using, for example, the variable c in formula 1. Therefore, the terminal 80 may arbitrarily adjust the change in the thickness W of the line. In addition, the flight height H may be an absolute height or a relative height. The change in the thickness W of the line relative to the flight height H of the flight path FP may be appropriately adjusted regardless of whether the height is an absolute height or a relative height.

The terminal control member 81 may obtain the minimum height Hmin in the flight path FP and the possible range of the thickness W of the line. The possible range of the thickness W of the line may be determined, for example, based on the minimum thickness Wmin and the maximum thickness Wmax. The terminal control member 81 may determine the thickness W of the line at each position in the flight path FP based on the minimum height Hmin and the possible range of the thickness W of the line. For example, the terminal 80 may determine the thickness W of the line based on the possible range of the thickness W capable of displaying the lines of the flight path generation application or the flight path display application. Therefore, a user may observe the thickness W of the accurately displayed line and accurately and intuitively confirm the flight height H of the flight path FP.

A second display mode of the flight path FP will be described below.

The second display mode is a display mode in which a color of the line representing the flight path FP varies with the height of the flight path FP. The color of the line may be determined based on at least one of a hue, saturation, or brightness. The brightness herein may be the lightness in the hue, saturation, lightness (HSL) color space, a value in the hue, saturation, value (HSV) color space, or information indicating the brightness in another color space. The lightness in the HSL color space is used as an example. In addition, only the change in the brightness in the gradation may be considered.

For example, the hue of the color of the line representing the flight path FP may vary with a frequency of a spectrum of a color represented by visible light. In this case, the higher the flight height H, the closer the color is to red, and the lower the flight height H, the closer the color is to purple. In addition, the brightness of the color of the line representing the flight path FP may vary with an amount of sunlight corresponding to an altitude. In this case, the higher the flight height H, the brighter (the greater the brightness of) the color of the line representing the flight path FP; and the lower the flight height H, the darker (the lower the brightness of) the color of the line representing the flight path FP.

The flight path FP may be drawn in this manner such that a user may understand the flight height H at each position in the flight path based on the color of the line representing the flight path FP. In addition, the terminal 80 may use the brightness to reflect the flight height H, and the change in the brightness may be set to approximate to human perception. The color of the line may further include the transparency of the line. In other words, the terminal control member 81 may change the transparency of the line based on the flight height H of the flight path FP.

In addition, the terminal 80 may display supplementary information AI indicating the correspondence between specific colors and various flight heights H. The supplementary information AI may be displayed on the 2D map MP or may be displayed separately from the 2D map MP.

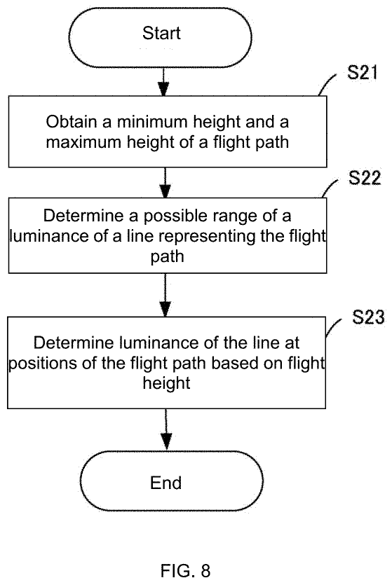

FIG. 8 is a flowchart of an example of actions of the terminal 80 when the flight path FP is displayed in the second display mode.

The terminal control member 81 may obtain the 2D map MP (S21). The terminal control member 81 may obtain the information about the flight path FP (S21). The terminal control member 81 may obtain the minimum height Hmin and a maximum height Hmax in the flight heights H at the positions of the flight path FP (S21).

The terminal control member 81 may determine a possible range of the brightness L of the line representing the flight path FP (S22). A minimum value (minimum brightness) of the possible range of the brightness L of the line is set as a minimum brightness Lmin, and a maximum value (maximum brightness) is set as a maximum brightness Lmax. The possible range of the brightness L of the line may be determined based on specifications of the terminal 80, an application to be executed (for example, flight path generation application or flight path display application), and the like.

The terminal control member 81 may determine the brightness L of the drawn line at the position of the flight height H in the flight path FP, for example, based on Formula 2 (S23).

$$\begin{matrix}Formula 2 & \\ L = L min + \frac{L max - L min}{H max - H min} \cdot ( H - H min ) & ( 2 )\end{matrix}$$

In the case of Formula 2, the minimum brightness Lmin corresponds to the minimum height Hmin, and the maximum brightness Lmax corresponds to the maximum height Hmax. The change in the brightness is proportional to the change in the flight height H.

In the second display mode, the flight height H may be an absolute height (altitude) or a relative height, as in the first display mode. In addition, the terminal control member 81 may determine whether the flight height H is an absolute height or a relative height via the operation member 83.

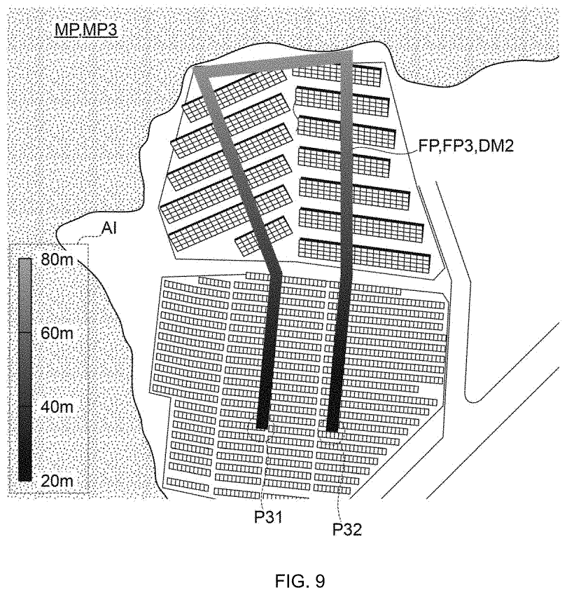

FIG. 9 is a diagram of a display example of a flight path FP3 (third flight path) in the display mode DM2 (second display mode). The flight path FP3 is an example of the flight path FP. On a 2D map MP3 shown in FIG. 9, the flight path FP3 may be superimposed and displayed. The 2D map MP3 is an example of the 2D map MP. The flight path FP3 is a path for investigating a solar panel disposed on a hillside. In the flight path FP3, the flight height H of the flight path FP3 varies along a slope of the hillside. The height of the UAV 100 relative to the ground is maintained fixed.

In the display mode DM2 shown in FIG. 9, positions P31 and P32 are in a lower part of the hillside. Since the flight height H thereof is small, the brightness L of the line representing the flight path FP3 is small. A position near a center between the positions P31 and P32 is in an upper part of the hillside. Since the flight height H is high; the brightness L of the line representing the flight path FP3 is large. A user may easily understand the flight height H at each position of the flight path FP3 by recognizing the brightness L of the line representing the flight path FP3. In addition, an overall situation of the flight in the flight path FP3 may be provided in such a way that a user may easily control the UAV 100 to fly up and down along the hillside.

In FIG. 9, supplementary information AI may be displayed on the 2D map MP3. The supplementary information AI indicates the correspondence between brightness L and the flight height H. In FIG. 9, the supplementary information AI shows a bar scale indicating a correspondence between the flight height H and the brightness L.

FIG. 9 illustrates a flight range in which the height of the ground may change. However, even if in a flight range in which the height of the ground is fixed, when the flight height H of the flight path FP in the flight range changes, the brightness of the line representing the flight path FP also changes. In addition, even if in the case of a cliff or a valley, the brightness of the line representing the flight path FP is fixed when the flight height H of the flight path FP is fixed regardless of the height of the ground.

In this way, the terminal control member 81 of the terminal 80 may determine the color of the line representing the flight path FP superimposed and displayed on the 2D map MP based on the flight height H of the flight path FP. Since the flight height H of the flight path FP is reflected by the color of the line representing the flight path FP, a user may understand the change in the flight height H at each position of the flight path FP by recognizing the color of the line.

In addition, the terminal control member 81 may determine the brightness L (an example of the brightness) of the line. Since the flight height H of the flight path FP is reflected by the brightness of the line representing the flight path FP, a user may understand the change in the flight height H at each position of the flight path FP by recognizing the brightness of the line.

In addition, the higher the height H of the flight path FP, the greater the brightness L of the line may be; the lower the height of the flight path FP, the lower the brightness L of the line may be (that is, the height of the flight path is positively correlated with the brightness of the line). The 2D map may be generated based on an image captured in the direction from the air toward the ground. Therefore, a state of the brightness L of the line representing the flight path FP may be the same as a state of a brightness L of an object irradiated by sunlight. Therefore, a user may easily and intuitively understand the flight height H of the flight path FP displayed on the 2D map MP.

In addition, the terminal control member 81 may obtain a height range of the flight path FP. The height range may be determined based on the minimum height Hmin and the maximum height Hmax of the flight path FP. The terminal control member 81 may obtain the possible range of the brightness L of the line representing the flight path FP. The possible range of the brightness L of the line may be determined based on the minimum brightness Lmin and the maximum brightness Lmax. The terminal control member 81 may determine the brightness L of the line at each position in the flight path FP based on the height range and the possible range of the brightness L of the line. For example, the terminal 80 may determine the brightness L of the line based on the possible range of the brightness L capable of displaying lines of the flight path generation application or the flight path display application. Therefore, a user may accurately observe the brightness L of the displayed line and accurately and intuitively recognize the flight height H of the flight path FP.

In addition, the terminal control member 81 may enable the display member 88 to display the supplementary information AI indicating the correspondence between the flight height H of the flight path FP and the brightness L (an example of the color) of the line representing the flight path FP. Therefore, a user may easily recognize the flight height H in the flight path FP based on the brightness L by viewing the supplementary information AI. For example, even if a color at a position at which the flight path FP is superimposed on the 2D map MP is the same as the color of the line representing the flight height H of the flight path FP, the terminal 80 may use the supplementary information AI to facilitate understanding of the flight height H of the flight path FP.

The terminal 80 may alternatively display the flight path FP in a display mode that is a combination of the first display mode and the second display mode. For example, the terminal control member 81 may adjust both the thickness W and the color of the line representing the displayed flight path FP.

The present disclosure is described above with reference to some exemplary embodiments. However, the technical scope of the present disclosure is not limited to the scope described in the foregoing exemplary embodiments. Apparently, a person of ordinary skill in the art may make various changes or improvements to the exemplary embodiments. It is understood from the claims that all such changes or improvements should be included within the technical scope of the present disclosure.

The execution order of the actions, sequences, steps, and stages of the apparatuses, systems, programs, and methods in the claims, specification, and accompanying drawings may be implemented in any order, provided that there is no special statement such as “before . . . ” or “in advance”, and an output of previous processing is not used in subsequent processing. The operation procedures in the claims, specification, and accompanying drawings are described by using “first,” “next,” etc. for convenience. However, it is not necessary to perform embodiments of the present disclosure in such a specific order.

### REFERENCE NUMERALS

10 Flight object system
80 Terminal
81 Terminal control member
83 Operation member
85 Communication member
87 Storage member
88 Display member
100 Unmanned aerial vehicle (UAV)
110 UAV control member
150 Communication member
160 Storage member
200 Gimbal
210 Rotor mechanism
220 Photographing member
240 GPS receiver
250 Inertial measurement unit (IMU)
260 Magnetic compass
270 Barometric altimeter
280 Ultrasonic sensor
290 Laser measurement instrument
MP, MP1, MP2, and MP3 2D map
FP, FP1, FP2, and FP3 flight path
DM1 and DM2 display mode

What is claimed is:

1. A display control method to control display of a flight path of a flight object, comprising:
obtaining a two-dimensional (2D) map including longitude and latitude information;
obtaining a flight path of a flight object in a three-dimensional (3D) space; and
determining, based on a height of the flight path, a display mode of the flight path superimposed and displayed on the 2D map.

2. The display control method according to claim 1, wherein the determining of the display mode of the flight path includes:
determining, based on a height of the flight path, a thickness of a line representing the flight path superimposed and displayed on the 2D map.

3. The display control method according to claim 2, wherein the height of the flight path is positively correlated with the thickness of the line representing the flight path.

4. The display control method according to claim 2, wherein the determining the thickness of the line includes:
adjusting the thickness of the line based on a change in the height of the flight path.

5. The display control method according to 2, wherein the determining of the thickness of the line includes:
obtaining a minimum height in the flight path;
obtaining a possible range of the thickness of the line; and
determining the thickness of the line at positions in the flight path based on the minimum height and the possible range of the thickness of the line.

6. The display control method according to claim 1, wherein the determining of the display mode of the flight path includes:
determining, based on the height of the flight path, a color of the line representing the flight path superimposed and displayed on the 2D map.

7. The display control method according to claim 6, wherein the determining of the color of the line representing the flight path includes:
determining a brightness of the line.

8. The display control method according to claim 7, wherein the height of the flight path is positively correlated with the brightness of the line.

9. The display control method according to claim 7, wherein the determining of the brightness of the line includes:
obtaining a range of the height of the flight path;
obtaining a possible range of the brightness of the line; and
determining the brightness of the line at positions in the flight path based on the range of the height and the possible range of the brightness of the line.

10. The display control method according to claim 1, wherein the obtaining of the flight path includes:
specifying a plurality of 2D positions at which the flight object flies by on a 2D plane represented by the 2D map and heights at the plurality of 2D positions; and
determining the flight path in the 3D space based on the plurality of 2D positions and the heights.

11. The display control method according to claim 1, further comprising:
superimposing the flight path on the 2D map in a determined display mode; and
displaying the flight path on a display member.

12. The display control method according to claim 11, wherein
the determining of the display mode of the flight path includes: determining, based on the height of the flight path, a color of a line representing the flight path superimposed and displayed on the 2D map; and
the superimposing of the flight path includes: displaying supplementary information indicating a correspondence between the height of the flight path and the color of the line representing the flight path.

13. A display control apparatus configured to control display of a flight path of a flight object, comprising:
a processing member, configured to:
obtain a two-dimensional (2D) map including longitude and latitude information,
obtain a flight path of a flight object in a three-dimensional (3D) space, and
determine, based on a height of the flight path, a display mode of the flight path superimposed and displayed on the 2D map.

14. The display control apparatus according to claim 13, wherein to determine the display mode of the flight path, the processing member is configured to:
determine, based on a height of the flight path, a thickness of a line representing the flight path superimposed and displayed on the 2D map.

15. The display control apparatus according to claim 14, wherein the height of the flight path is positively correlated with the thickness of the line representing the flight path.

16. The display control apparatus according to claim 14, wherein to determine the thickness of the line, the processing member is configured to:
adjust the thickness of the line based on a change in the height of the flight path.

17. The display control apparatus according to claim 14, wherein to determine the thickness of the line, the processing member is configured to:
obtain a minimum height in the flight path;
obtain a possible range of the thickness of the line; and
determine the thickness of the line at positions in the flight path based on the minimum height and the possible range of the thickness of the line.

18. The display control apparatus according to claim 13, wherein to determine the display mode of the flight path, the processing member is configured to:
determine, based on the height of the flight path, a color of the line representing the flight path superimposed and displayed on the 2D map.

19. The display control apparatus according to claim 13, wherein to obtain the flight path, the processing member is configured to:
specify a plurality of 2D positions at which the flight object flies by on a 2D plane represented by the 2D map and heights at the plurality of 2D positions; and
determine the flight path in the 3D space based on the plurality of 2D positions and the heights.

20. A computer-readable recording medium having a program to enable a display control apparatus configured to control display of a flight path of a flight object to:
obtain a two-dimensional (2D) map including longitude and latitude information,
obtain a flight path of a flight object in a three-dimensional (3D) space, and
determine, based on a height of the flight path, a display mode of the flight path superimposed and displayed on the 2D map.
